(19) United States
(12) Patent Application Publication
(10) Pub. No.: US 2007/0188428 A1
(43) Pub. Date: Aug. 16, 2007

(54) LIQUID CRYSTAL DISPLAY APPARATUS AND LIQUID CRYSTAL DISPLAY METHOD

(76) Inventors: Kazuhiro Nishiyama, Kanazawa-shi (JP); Mitsutaka Okita, Hakusan-shi (JP); Daiichi Suzuki, Sendai-shi (JP); Shigesumi Araki, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/669,421

(22) Filed: Jan. 31, 2007

(30) Foreign Application Priority Data
Jan. 31, 2006 (JP) 2006-023777

(51) Int. Cl. G09G 3/36

(52) U.S. Cl. 345/87

(57) ABSTRACT

A liquid crystal display apparatus includes crystal pixels, and a drive controller which makes the liquid crystal pixels hold a pixel voltage corresponding to a video signal for a first period and a non-video signal for a second period, and cyclically repeats the first and second periods, wherein the drive controller has a setting unit to set a value corresponding to the length of the second period, and a range changing unit to change a voltage range of a pixel voltage corresponding to the video signal corresponding to the value set, and the range changing unit changes a pixel voltage of a high luminance side and enlarges a pixel voltage range as a ratio of the second period to the first period is increased corresponding to the value, and changes a pixel voltage of a high luminance side and narrows a pixel voltage range as the ratio is decreased.

### CROSS-REFERENCE TO RELATED APPLICATIONS

This application is based upon and claims the benefit of priority from prior Japanese Patent Application No. 2006-023777, filed Jan. 31, 2006, the entire contents of which are incorporated herein by reference.

### BACKGROUND OF THE INVENTION

1. Field of the Invention

The present invention relates to a liquid crystal display apparatus and a liquid crystal display method for cyclically displaying video signals and non-video signals of minimum gradation for black image or intermediate gradation close to black image on a liquid crystal panel of OCB (Optically Compensated Bend) mode, for example.

2. Description of the Related Art

Recently, in the field of liquid crystal television and cellular phone, attention has been focused on a liquid crystal display panel of OCB mode having high-speed liquid crystal response required for displaying a moving image.

An OCB liquid crystal display panel includes an array substrate, an opposite substrate, and a liquid crystal layer held between the array substrate and opposite substrate. An array substrate generally has pixel electrodes covered by an alignment layer and arranged in a matrix form. An opposite substrate has an opposite electrode covered by an alignment layer and opposed to pixel electrodes. When a liquid crystal display panel is of a light transmission type, a pair of polarizing plates is stuck to an array substrate and an opposite substrate through an optical phase difference plate.

An array substrate has pixel electrodes arranged in a matrix form. An opposite substrate has a common electrode opposite to these pixel electrodes. The pixel electrodes and common electrode constitute a liquid crystal pixel together with a liquid crystal layer sandwiched therebetween in a pixel area. Liquid crystal molecules in a pixel area are controlled by an electric field between the pixel electrode and common electrode.

A liquid crystal panel performs displaying as follows. A digital video signal for a liquid crystal pixel is converted to an analog pixel voltage by selectively using a predetermined number of gradation reference voltage generated in a gradation reference voltage generation circuit. A converted analog pixel voltage is output to a liquid crystal pixel (Jpn. Pat. Appln. KOKAI Publication No. 2002-202491).

Black insertion drive may be applied to a liquid crystal panel in order to improve the characteristics of displaying a moving image. Black insertion drive is a method of applying a black voltage not corresponding to a video signal to a liquid crystal electrode as a pixel voltage cyclically and alternately with a pixel voltage corresponding to a video signal. Increased black insertion rate improves visibility of a moving image, and enables video display comparable to CRT.

To improve the characteristics of displaying a moving image furthermore, variable black insertion rate in black insertion drive in accordance with temperature or image displaying characteristics, has been proposed (Jpn. Pat. Appln. KOKAI Publication No. 2003-295156).

Particularly, in an OCB liquid crystal panel, a reverse transition from bend alignment allowing display to spray alignment can be effectively prevented by combining the above black insertion drive.

### BRIEF SUMMARY OF THE INVENTION

According to a first aspect of the invention, there is provided a liquid crystal display apparatus comprising liquid crystal pixels; and a drive controller which makes the liquid crystal pixels hold a pixel voltage corresponding to a video signal for a first period and a pixel voltage corresponding to a non-video signal for a second period, and cyclically repeats the first and second periods, wherein the drive controller has a setting unit configured to set a value corresponding to the length of the second period, and a voltage range changing unit configured to change a voltage range of a pixel voltage corresponding to the video signal corresponding to the value set by the setting unit, and the voltage range changing unit changes a pixel voltage of a high luminance side and enlarges a pixel voltage range as a ratio of the second period to the first period is increased corresponding to the value, and changes a pixel voltage of a high luminance side and narrows a pixel voltage range as the ratio is decreased.

According to a second aspect of the invention, there is provided a liquid crystal display method of a liquid crystal display apparatus having liquid crystal pixels, and a drive controller which makes the liquid crystal pixels hold a pixel voltage corresponding to a video signal for a first period and a pixel voltage corresponding to a non-video signal for a second period, and cyclically repeats the first and second periods, comprising: setting a value corresponding to the length of the second period, changing a voltage range of a pixel voltage corresponding to the video signal corresponding to the set value, changing a pixel voltage of a high luminance side and enlarging a pixel voltage range as a ratio of the second period to the first period is increased corresponding to the value, and changing a pixel voltage of a high luminance side and narrowing a pixel voltage range as the ratio is decreased.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 diagrammatically shows a circuit configuration of a liquid crystal display apparatus according to an embodiment of the invention;

FIG. 2 is a diagram showing a configuration of a source driver;

FIG. 3 is a diagram showing a gradation reference voltage generation circuit and a DA conversion circuit in details;

FIG. 4 is a graph showing a relationship between a color reproduction range and gradation of a liquid crystal display panel;

FIG. 5A shows an optical response waveform of a liquid crystal obtained when black insertion drive of conventional control system is performed for a liquid crystal display panel;

FIG. 5B shows an optical response waveform of a liquid crystal obtained when black insertion drive of conventional control system is performed for a liquid crystal display panel;

FIG. 6 is a graph showing a relationship between a pixel voltage and a liquid crystal modulation rate of a liquid crystal display panel;

FIG. 7 is a conceptual illustration showing an optical response waveform of a liquid crystal obtained when black insertion drive of a control system of this embodiment is performed for a liquid crystal display panel;

FIG. 8 is a graph showing a relationship between pixel voltage and liquid crystal modulation rate when a liquid crystal display panel is a normally black mode; and

FIG. 9 shows a configuration example of a reference value table.

### DETAILED DESCRIPTION OF THE INVENTION

### Embodiment 1

A light-transmission type liquid crystal display apparatus according to an embodiment of the invention will be explained hereinafter with reference to the accompanying drawings.

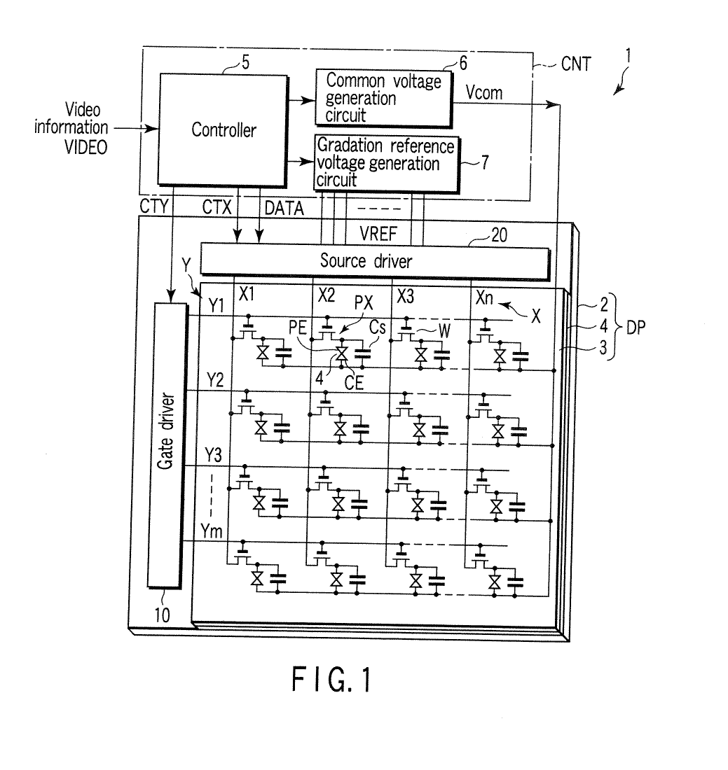

FIG. 1 diagrammatically shows a circuit configuration of a liquid crystal display apparatus 1.

A liquid crystal display apparatus 1 has an OCB liquid crystal display panel DP having OCB liquid crystal pixels PX, and a controller CNT to control the liquid crystal display panel DP. The liquid crystal display panel DP is constructed to have a liquid crystal layer 4 held between an array substrate 2 and an opposite substrate 3.

The display panel control circuit CNT controls transmissivity of the liquid crystal display panel DP by changing a liquid crystal driving voltage applied to the liquid crystal layer 4 from the array substrate 2 and opposite substrate 3.

As display is executed in a normally white mode, when a relatively large electric field is applied to a liquid crystal from the display panel control circuit CNT upon turning on, alignment of liquid crystal is transferred from spray alignment state to bend alignment state to enable display.

Spray alignment is energetically more stable than bend alignment in the state that a liquid crystal driving voltage is not applied. Therefore, in an OCB liquid crystal display panel DP, alignment state of liquid crystal is spray alignment state before power is turned on. Even after transferring to the bend alignment, if a sate with no voltage applied or a state that a voltage lower than the level where spray alignment energy is comparable to bend alignment energy is continued for a long time, liquid crystal is transferred again to the spray alignment.

In the prior art, for preventing such reverse transition from bend alignment to spray alignment, a driving system that applies a large voltage to liquid crystal for each frame to display an image of one frame is adopted. In a normally white liquid crystal display panel, by setting this voltage to a pixel voltage that becomes black display, visibility of moving images can be improved as well as preventing the above reverse transition. Therefore, this is called black insertion drive.

The array substrate 2 has pixel electrodes PE, gate lines Y (Yl-Ym), source lines X (Xl-Xn), a pixel switching element W, a gate driver 10, and a source driver 20.

The pixel electrodes PE are arranged in a matrix form on a transparent insulating substrate such as glass. The gate lines Y (Yl-Ym) are arranged along the row direction of pixel electrodes PE. The source lines X (Xl-Xn) are arranged along the column direction of pixel electrodes PE. The pixel switching element W is arranged close to the intersection of these gate lines Y and source lines X. The gate driver 10 sequentially drives the gate lines Y. The source driver 20 drives the source lines X while the gate lines Y are driven.

The pixel switching element W is composed of a polysilicone thin-film transistor, for example. In this case, a gate of a thin-film transistor is connected to one gate line Y, and a source and a drain path are connected to one corresponding source line X and pixel electrode PE, respectively.

The gate driver 10 is composed of a polysilicone thin-film transistor formed in the same process of forming the pixel switching element W. The source driver 20 is an integrated circuit (IC) chip mounted on the array substrate 2 by COG (Chip On Glass) technology. The source driver 20 may be formed by using a polysilicone thin-film transistor formed in the same process of forming the pixel switching element W as in the gate driver 10.

The opposite substrate 3 includes a color filter (not shown), and a common electrode CE. The color filter is composed of red, green and blue colored layers arranged on a transparent glass insulating substrate and opposite to the pixel electrodes PE in a column direction. The common electrode XE is arranged on a color filter, and opposite to the whole pixel electrodes PE.

The pixel electrode PE and common electrode CE are made of transparent electrode material such as ITO. When composing as a reflection type, the pixel electrode PE can be composed of a reflector made of aluminum. An alignment state of Liquid crystal molecules in the liquid crystal layer 4 is controlled corresponding to the electric fields from the pixel electrode PE and common electrode CE. The pixel electrode PE, common electrode CE and liquid crystal layer 4 constitute an OCB liquid crystal pixel PX. Each pixel PX has an auxiliary capacitance Cs. The auxiliary capacitance Cs is obtained by electrically connecting the common electrode CE to auxiliary capacitance lines capacity coupling with pixel electrodes PE in a row direction in the array substrate 2.

The controller CNT includes a controller 5, a common voltage generation circuit 6, and a gradation reference voltage generation circuit 7.

The controller 5 controls the common voltage generation circuit 6, gradation reference voltage generation circuit 7, gate driver 10, and a source driver 20, to display externally supplied digital video information VIDEO on the liquid crystal display panel DP.

The common voltage generation circuit 6 generates a common voltage Vcom for the common electrode CE on the opposite substrate 3. The gradation reference voltage generation circuit 7 generates gradation reference voltage VREF. The gradation reference voltage VREF is used to convert 8-bit display signal DATA obtained from the video information VIDEO for each pixel PX into a pixel voltage. Here, the pixel voltage is a voltage applied to the pixel electrode PE with reference to the potential of the common electrode CE as a reference.

The gate driver 10 drives the gate lines Yl-Ym to make the switching elements W conductive by line-at-a-time. The source driver 20 outputs a pixel voltage to the source lines X1-Xn in the period that the switching element W of each line is made conductive by the driving of the corresponding gate line Y. The controller 5 performs black insertion conversion for the video signal included in the externally supplied video information VIDEO, and controls the operation timing of the gate driver 10 and source driver 20 for the conversion result.

The pixel voltage is a voltage applied to the pixel electrode PE with reference to the common voltage Vcom of the common electrode CE. The pixel voltage is inverted to the common voltage Vcom to perform line inversion drive and frame inversion drive (1H1V inversion drive), for example. The video information VIDEO consists of video signals for all liquid crystal pixels PX, and updated for each one frame period (vertical scanning period V).

In the black insertion, the video information VIDEO of one frame is converted for one line, that is, converted to a non-video signal for black insertion B and a video signal S for one line for each pixel PX of one line.

The video signal S indicates minimum to maximum gradations, and the non-video signal for black insertion B indicates gradation of black image or gradation close to black image. The non-video signal B for one line and video signal S for one line are output in series from the controller 5 as display signal DATA in the period of H/2. The controller 5 generates a control signal CTY and a control signal CTX.

The control signal CTY is supplied from the controller 5 to the gate driver 10, and used to sequentially select the gate lines Y for each one vertical scanning period. The gate driver 10 sequentially selects the gate lines Y under the control of the control signal CTY, and supplies a scanning signal to make the pixel switching element W conductive to the selected gate line Y.

The control signal CTX is supplied from the controller 5 to the source driver 20, and used to assign a display signal DATA including a video signal or a non-video signal corresponding to pixels of one line, to source lines X. The control signal CTX includes a horizontal start signal STH, a horizontal clock signal CKH, a strobe signal STB, and a polarity signal POL. The horizontal start signal STH is a pulse generated at every H/2 period. The horizontal clock signal CKH is a pulse generated for the number of sources in each H/2 period. The strobe signal STB is a pulse generated a predetermined time later than the start signal STH. The strobe signal STB is used to output a pixel voltage that is the conversion result of the display signal DATA for the pixels PX of one line, parallel to the source lines X1-Xn. The polarity signal POL is a signal to invert the polarity of the pixel voltage at every one horizontal scanning period and one vertical scanning period.

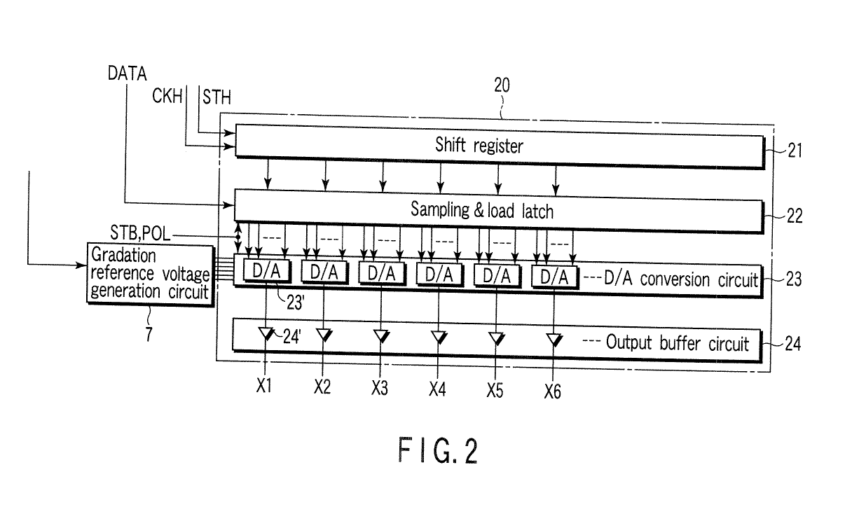

FIG. 2 shows a configuration of the source driver shown in FIG. 1.

The source driver 20 includes a shift register 21, a sampling & load latch 22, a digital-to-analog (DA) conversion circuit 23, and an output buffer circuit 24.

The shift register 21 shifts the horizontal start signal STH in synchronization with the horizontal clock signal CKH, and controls the timing of sequentially serial/parallel converting the display signal DATA. The sampling & load latch 22 sequentially latches and parallel outputs the display signal DATA for the pixels of one line under the control of the shift register 21. The DA conversion circuit 23 converts the display signal DATA to an analog pixel voltage. The output buffer circuit 24 outputs the analog pixel voltage obtained from the DA conversion circuit 23 to the sources lines X1-Xn. The DA conversion circuit 23 is configured to refer the gradation reference voltage VREF generated from the gradation reference voltage generation circuit 7.

The above explained operations of the gate driver 10 and source driver 20 are executed for the non-video signal B for black insertion of one frame and video signal S of one frame. By changing the period of holding the pixel voltage corresponding to the video signal S for the period of holding the pixel voltage corresponding to the non-video signal B for black insertion, the black insertion rate, or the ratio of the period of holding the pixel voltage corresponding to the non-video signal B for one frame period can be changed.

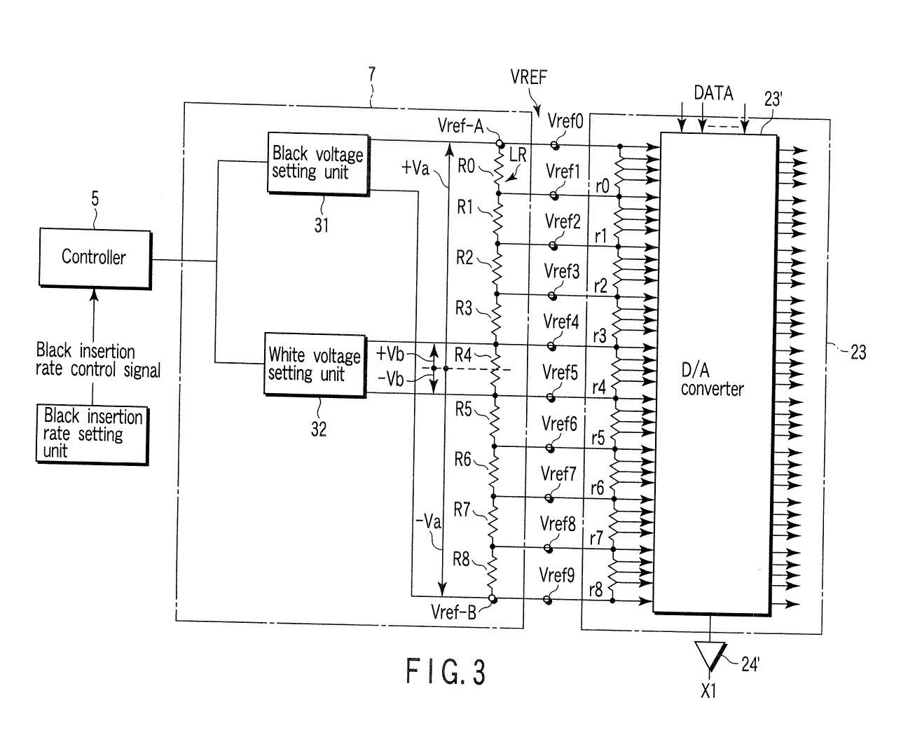

FIG. 3 shows in details the gradation reference voltage generation circuit and DA conversion circuit shown in FIG. 2.

The gradation reference voltage generation circuit 7 includes a black voltage setting unit 31, a white voltage setting unit 32, and a ladder resistor LR. The black voltage setting unit 31 sets a black voltage, or a first supply voltage for minimum gradation. The white voltage setting unit 32 sets a white voltage, or a second supply voltage for maximum gradation. The ladder resistor LR is connected to the black voltage setting unit 31 and white voltage setting unit 32, to divide the difference voltage between the first and second supply voltage into a predetermined number of gradation reference voltage Vref0-Vref9.

The ladder resistor LR is composed of resistors R0-R8 connected in series between the power supply terminals Vref_A and Vref_B. The first supply voltage is supplied to the power supply terminals Vref_A and Vref_B to obtain positive black voltage +Va and negative black voltage −Va with respect to a center point of division. The second supply voltage is supplied to both ends of a resistor R4 including a center point of division in the ladder resistor LR, to obtain positive white voltage +Vb and negative white voltage −Vb with respect to a center point of division.

The DA conversion circuit 23 of the source driver 20 is composed of DA converters 23′ and input resistors r0-r8 connected between the voltage output terminals of the gradation reference voltage generation circuit 7, for example, as shown in FIG. 2. The input resistors r0-r8 are provided common to the DA converters 23′, and output a predetermined number of gradation reference voltage obtained by dividing the voltage between these voltage output terminals, to the DA converters 23′.

Each DA converter 23′ selects one of the predetermined number of gradation reference voltage corresponding to the distal display signal DATA output from the sampling & load latch 22, and outputs the selected reference voltage to the output buffer circuit 24 as an analog pixel voltage. The output buffer circuit 24 is composed of buffer amplifiers 24′ to output the analog pixel voltage from the DA converter 23′ to the source lines X1, X2, X3, . . . .

The DA conversion circuit 23 and output buffer circuit 24 form a signal conversion circuit. Namely, the DA conversion circuit 23 and output buffer circuit 24 convert the display signal DATA of one line to pixel voltage by selectively using the predetermined number of gradation reference voltage obtained from the input resistors r0-r8, and output the converted pixel voltage to the source lines X1-Xn.

The pixel voltage on the source lines X1-Xn are supplied to the corresponding pixel electrodes PE through the pixel switching element W of one line driven by a scanning signal. The common voltage Vcom is output from the common voltage generation circuit 6 to the common electrode CE in synchronization with the output timing of the pixel voltage. In the source driver 20, each DA converter 23′ inverts the polarity of the pixel voltage for the center voltage of dividing equal to the common voltage Vcom.

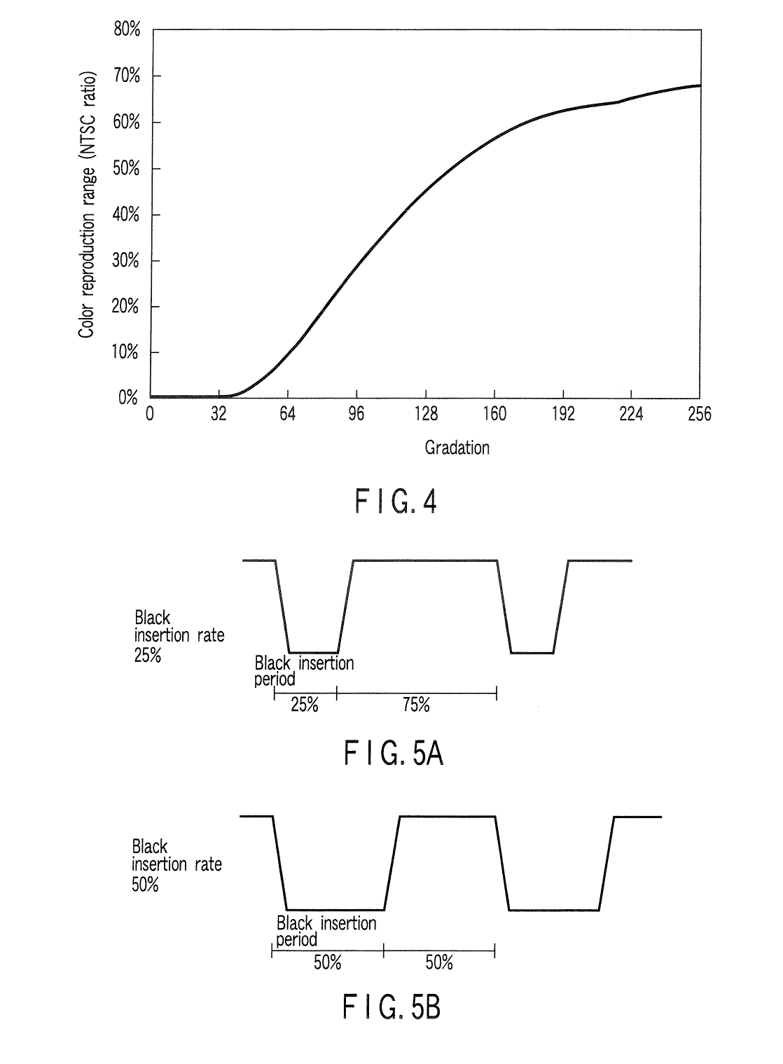

FIG. 4 shows the relationship between the color reproduction range and gradation of the liquid crystal display panel shown in FIG. 1. The horizontal axis indicates the gradation number, and the vertical axis indicates the color reproduction range (NTSC ratio).

As seen from the graph, as the gradation number becomes small, that is, becoming dark, the color reproduction range is lowered by the influences of refractivity dependence of liquid crystal and leak of light from a black display pixel.

FIGS. 5A and 5B show optical response waveforms of a liquid crystal obtained when black insertion drive of conventional control system is performed for the liquid crystal display panel shown in FIG. 1. FIG. 5A shows an optical response waveform when the black insertion rate is 25%, and FIG. 5B shows an optical response waveform when the black insertion rate is 50%. In these drawings, the vertical axis indicates luminance, and the horizontal axis indicates transition of time.

Comparing the optical response waveforms when the black insertion rate is 25% and 50%, as the display period of minimum black gradation or intermediate gradation close to black is Increased in one frame period, the luminance is lowered and the contrast is accordingly lowered. As the ratio of response part for black display is relatively increased by increasing the black insertion rate, not only the luminance is lowered, but also the color purities of red, green and blue become bad, and the color reproduction range becomes narrow.

In this liquid crystal display apparatus, the black insertion rate can be changed to 25% or 50% by an external black insertion rate control signal supplied to the controller 5. The black insertion rate control signal may be variable with ambient temperatures, or varied with environmental illuminance or display images (moving and static images).

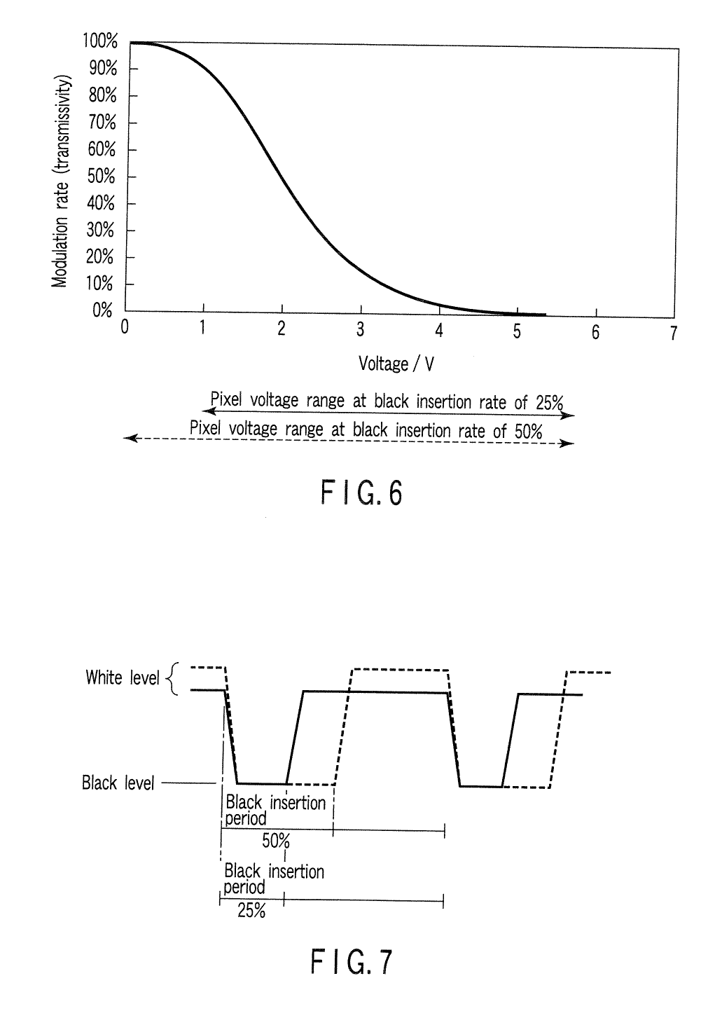

FIG. 6 shows the relationship between the pixel voltage and liquid crystal modulation rate of the liquid crystal display panel shown in FIG. 1. The horizontal axis indicates a pixel voltage, and the vertical axis indicates a modulation rate (transmissivity). This graph shows an example of normally white mode.

When an ambient temperature is a room temperature (approx. 25° C.) and a black insertion rate is set to 25% by an external black insertion rate control signal, the controller 5 controls the black voltage setting unit 31 and white voltage setting unit 32 so that a pixel voltage comes in a range of 1.0-5.8V as shown in FIG. 6.

Likewise, when an ambient temperature is a room temperature (approx. 25° C.) and a black insertion rate is set to 50% by an external black insertion rate control signal, the controller 5 controls the black voltage setting unit 31 and white voltage setting unit 32 so that a pixel voltage becomes a range of 0.2-5.8V as shown in FIG. 6.

As described above, the controller 5 controls to decrease a white voltage in response to an increase of black insertion rate, and to increase a white voltage larger in response to a decrease of black insertion rate. Namely, the controller 5 enlarges a pixel voltage range by changing a pixel voltage of a higher luminance side in response to an increase of black insertion rate, and reduces a pixel voltage range by changing a pixel voltage of a higher luminance side in response to a decrease of black insertion rate.

FIG. 7 is a conceptual illustration showing an optical response waveform of a liquid crystal obtained when black insertion drive of a control system of this embodiment is performed for the liquid crystal display panel shown in FIG. 1.

A white voltage is set low when a black insertion rate is 50%, and a maximum value of a white level response waveform is high. Namely, luminance is high compared with when a black insertion rate of 25%. As a result, contrast is improved, white display can be made in the high gradation side of the gradation-color reproduction characteristics shown in FIG. 4, and a decrease of color reproduction range can be suppressed.

When a black insertion rate is 25%, luminance, contrast and color reproduction range are 500 cd/m², 500:1 and 73%, respectively.

A pixel voltage range is not changed in a conventional display method, and when a black insertion rate is 50%, luminance, contrast and color reproduction range are 300 cd/m², 300:1 and 70%, respectively.

Contrarily, in this display method, a pixel voltage range is changed, and when a black insertion rate is 50%, luminance, contrast and color reproduction range are 350 cd/m², 350:1 and 71.8%, respectively. A decrease of luminance, contrast and color reproduction range can be suppressed.

Next, an explanation will be given on a modification in which a liquid crystal display panel DP is a normally black mode.

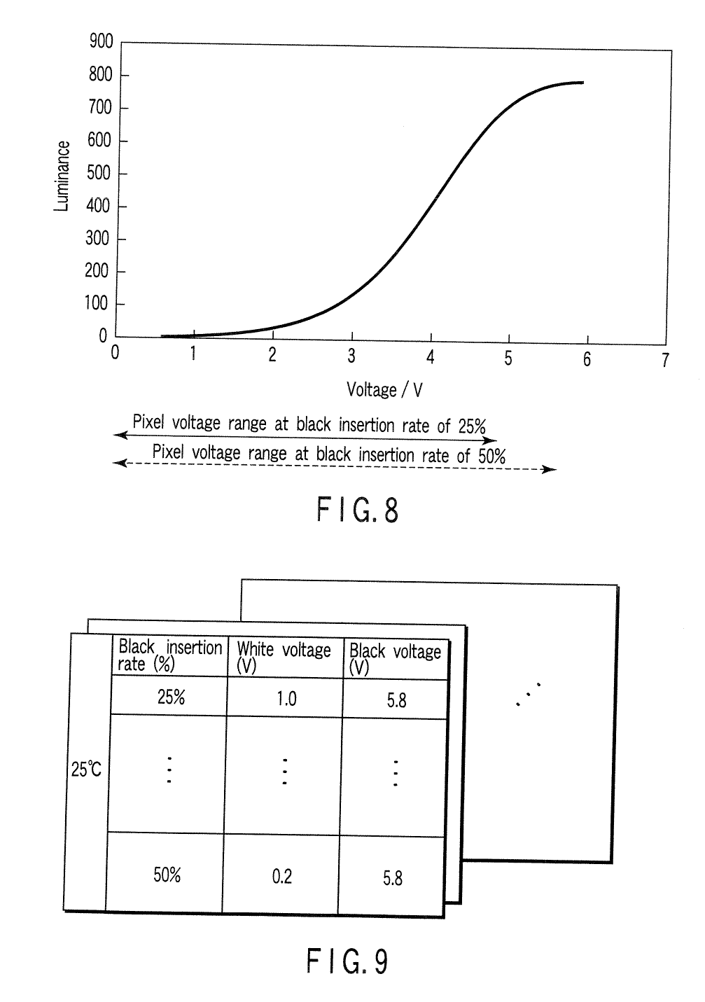

FIG. 8 is a graph showing a relationship between pixel voltage and liquid crystal modulation rate when the liquid crystal display panel shown in FIG. 1 is a normally black mode. The horizontal axis indicates a pixel voltage, and the vertical axis indicates a modulation rate.

When a black insertion rate is set to 25% by an external black insertion rate control signal, the controller 5 controls the black voltage setting unit 31 and white voltage setting unit 32 so that a pixel voltage comes in a range of 0-5.0V as shown in FIG. 8.

When a black insertion rate is set to 50% by an external black insertion rate control signal, the controller 5 controls the black voltage setting unit 31 and white voltage setting unit 32 so that a pixel voltage comes in a range of 0-5.8V as shown in FIG. 8.

As described above, the controller 5 controls to increase a white voltage in response to an increase of black insertion rate, and to decrease a white voltage in response to a decrease of black insertion rate. Namely, the controller 5 enlarges a pixel voltage range by changing a pixel voltage of a higher luminance side in response to an increase of black insertion rate, and reduces a pixel voltage range by changing a pixel voltage of a higher luminance side in response to a decrease of black insertion rate.

An optical response waveform for white display when applying the method of this variation is the same as the waveform of FIG. 7, and detailed explanation will be omitted.

A white voltage is set high when a black insertion rate is 50%, and a maximum value of a white level response waveform is high. Namely, luminance is high compared with when a black insertion rate of 25%. As a result, contrast is improved, white display can be made in the high gradation side of the gradation-color reproduction characteristics shown in FIG. 4, and a decrease of color reproduction range can be suppressed.

When a black insertion rate is 25%, luminance, contrast and color reproduction range are 500 cd/m², 600:1 and 73%, respectively.

A pixel voltage range is not changed in a conventional display method, and when a black insertion rate is 50%, luminance, contrast and color reproduction range are 300 cd/m², 360:1 and 69%, respectively.

Contrarily, in this display method, a pixel voltage range is changed, and when a black insertion rate is 50%, luminance, contrast and color reproduction range are 350 cd/m², 420:1 and 71.5%, respectively. A decrease of luminance, contrast and color reproduction range can be suppressed.

A table listing the above reference values for each black insertion rate may be provided, and changed in response to changes in black insertion rate.

FIG. 9 shows a configuration example of a reference value table in a normally white mode.

Black insertion rate, white voltage, and black voltage are defined in this reference value table. This reference value table is provided for each liquid crystal display panel temperature.

When a black insertion rate is changed by an external black insertion rate control signal, the controller 5 reads a reference value table corresponding to a liquid crystal panel temperature. The controller takes out a black voltage value and a white voltage value corresponding to a display mode, and sets them in the black voltage setting unit 31 and white voltage setting unit 32, respectively. However, in this embodiment, only a white voltage value may be taken out and set in the white voltage setting unit 32.

In this embodiment, a black insertion rate is changed to 25% or 50%, but this method can be applied even if a black insertion rate is changed to more states.

Each function explained in the aforementioned embodiments may be configured by using hardware, or may be realized by using software and reading a program describing each function into a computer. Each function may be configured by appropriately selecting software and hardware.

Each function can also be realized by reading a program stored in a not-shown recording medium into a computer. A recording medium in this embodiment may be of any recording format, as long as it can record a program and can be read by a computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display apparatus comprising liquid crystal pixels; and a drive controller which makes the liquid crystal pixels hold a pixel voltage corresponding to a video signal for a first period and a pixel voltage corresponding to a non-video signal for a second period, and cyclically repeats the first and second periods,
wherein the drive controller has a setting unit configured to set a value corresponding to the length of the second period, and a voltage range changing unit configured to change a voltage range of a pixel voltage corresponding to the video signal corresponding to the value set by the setting unit, and
the voltage range changing unit changes a pixel voltage of a high luminance side and enlarges a pixel voltage range as a ratio of the second period to the first period is increased corresponding to the value, and changes a pixel voltage of a high luminance side and narrows a pixel voltage range as the ratio is decreased.

2. The liquid crystal display apparatus according to claim 1, wherein the drive controller has a gradation reference voltage generator which divides a difference voltage between a first supply voltage for minimum gradation and a second supply voltage for maximum gradation, and generates the predetermined number of gradation reference voltage, and a signal converter which converts the video and non-video signals to the pixel voltage by selectively using the predetermined number of gradation reference voltage obtained from the gradation reference voltage generator, and
the voltage range changing unit changes the second supply voltage.

3. The liquid crystal display apparatus according to claim 2, wherein the second supply voltage is set low to enlarge the pixel voltage range when the liquid crystal pixels are normally white mode.

4. The liquid crystal display apparatus according to claim 2, wherein the second supply voltage is set high to enlarge the pixel voltage range when the liquid crystal pixels are normally black mode.

5. The liquid crystal display apparatus according to claim 1, wherein the liquid crystal pixels are liquid crystal pixels of OCB mode.

6. The liquid crystal display apparatus according to claim 2, wherein the liquid crystal pixels are liquid crystal pixels of OCB mode.

7. The liquid crystal display apparatus according to claim 3, wherein the liquid crystal pixels are liquid crystal pixels of OCB mode.

8. The liquid crystal display apparatus according to claim 4, wherein the liquid crystal pixels are liquid crystal pixels of OCB mode.

9. A liquid crystal display method of a liquid crystal display apparatus having liquid crystal pixels, and a drive controller which makes the liquid crystal pixels hold a pixel voltage corresponding to a video signal for a first period and a pixel voltage corresponding to a non-video signal for a second period, and cyclically repeats the first and second periods, comprising:
setting a value corresponding to the length of the second period,
changing a voltage range of a pixel voltage corresponding to the video signal corresponding to the set value,
changing a pixel voltage of a high luminance side and enlarging a pixel voltage range as a ratio of the second period to the first period is increased corresponding to the value, and
changing a pixel voltage of a high luminance side and narrowing a pixel voltage range as the ratio is decreased.

10. The liquid crystal display method according to claim 9, further comprising:
dividing a difference voltage between a first supply voltage for minimum gradation and a second supply voltage for maximum gradation, and generating the predetermined number of gradation reference voltage; and
converting the video and non-video signals to the pixel voltage by selectively using the predetermined number of generated gradation reference voltage,
wherein changing a voltage range of the pixel voltage changes the second supply voltage.

11. The liquid crystal display method according to claim 10, wherein the second supply voltage is set low to enlarge the pixel voltage range when the liquid crystal pixels are normally white mode.

12. The liquid crystal display method according to claim 10, wherein the second supply voltage is set high to enlarge the pixel voltage range when the liquid crystal pixels are normally black mode.

13. The liquid crystal display method according to claim 9, wherein the liquid crystal pixels are liquid crystal pixels of OCB mode.

14. The liquid crystal display method according to claim 10, wherein the liquid crystal pixels are liquid crystal pixels of OCB mode.

15. The liquid crystal display method according to claim 11, wherein the liquid crystal pixels are liquid crystal pixels of OCB mode.

16. The liquid crystal display method according to claim 12, wherein the liquid crystal pixels are liquid crystal pixels of OCB mode.
